(19) United States
(12) Patent Application Publication
(10) Pub. No.: US 2026/0017751 A1
(43) Pub. Date: Jan. 15, 2026

(54) PANORAMIC IMAGE PROCESSING METHOD AND APPARATUS, ELECTRONIC DEVICE AND STORAGE MEDIUM

(71) Applicant: Douyin Vision Co., Ltd., Beijing (CN)

(72) Inventors: Dongbo ZHANG, Beijing (CN); Mingzhe TIAN, Beijing (CN); Shaohui JIAO, Beijing (CN)

(21) Appl. No.: 18/881,682

(22) PCT Filed: Nov. 22, 2023
(86) PCT No.: PCT/CN2023/133175

§ 371 Date: Jan. 6, 2025

(30) Foreign Application Priority Data
Dec. 13, 2022 (CN) 202211595183.7

(51) Int. Cl. G06T 3/4038; G06T 7/55

(52) U.S. Cl. CPC G06T 3/4038; G06T 7/55

(57) ABSTRACT

Provided in the present disclosure are a panoramic image processing method and apparatus, and an electronic device and a storage medium. The method comprises: acquiring a first image captured by a first image acquisition apparatus and a second image captured by a second image acquisition apparatus, and respectively converting the first image and the second image into a first panoramic image and a second panoramic image; determining parallax information between the first panoramic image and the second panoramic image, and generating depth information corresponding to the parallax information; and on the basis of the depth information, mapping the first image and the second image into the same device space, and according to a mapping result in the same device space, generating a stitched panoramic image of the first image and the second image.

### CROSS-REFERENCE TO RELATED APPLICATIONS

The present application is a U.S. National Stage application under 35 U.S.C. § 371 of International Application No. PCT/CN2023/133175, as filed on Nov. 22, 2023, which claims the priority of the Chinese Patent Application No. 202211595183.7 filed on Dec. 13, 2022, entitled “Panoramic Image Processing Method and Apparatus, Electronic Device and Storage Medium”, the disclosure of both applications are incorporated by reference herein in their entireties.

### TECHNICAL FIELD

The present disclosure relates to the technical field of image processing, and in particular to a panoramic image processing method and apparatus, an electronic device and a storage medium.

### BACKGROUND

At present, at the time of making a panoramic image with a wide range, a plurality of image acquisition apparatuses can be used to respectively capture images within their respective fields of view, and then the images within the respective fields of view are stitched together into a panoramic image with a wide range.

### SUMMARY

In view of this, one or more embodiments of the present disclosure provide a panoramic image processing method and apparatus, an electronic device, and a storage medium.

In an aspect, the present disclosure provides a panoramic image processing method, comprising: acquiring a first image captured by a first image acquisition apparatus and a second image captured by a second image acquisition apparatus, and respectively converting the first image and the second image into a first panoramic image and a second panoramic image; determining parallax information between the first panoramic image and the second panoramic image, and generating depth information corresponding to the parallax information; and based on the depth information, mapping the first image and the second image into the same device space and according to a mapping result in the same device space, generating a stitched panoramic image of the first image and the second image.

In a further aspect, the present disclosure further provides a panoramic image processing apparatus, comprising: a panoramic image conversion unit, configured to acquire a first image captured by a first image acquisition apparatus and a second image captured by a second image acquisition apparatus, and respectively convert the first image and the second image into a first panoramic image and a second panoramic image; a depth information generation unit, configured to determine parallax information between the first panoramic image and the second panoramic image, and generate depth information corresponding to the parallax information; and an image stitching unit, configured to map the first image and the second image into the same device space based on the depth information, and according to a mapping result in the same device space, generating a stitched panoramic image of the first image and the second image.

In a further aspect, the present disclosure further provides an electronic device, comprising a memory and a processor, wherein the memory is configured to store a computer program which, when executed by the processor, implements the above-mentioned panoramic image processing method.

In a further aspect, the present disclosure further provides a computer-readable storage medium configured to store a computer program which, when executed by a processor, implements the above-mentioned panoramic image processing method.

### BRIEF DESCRIPTION OF THE DRAWINGS

The features and advantages of the embodiments of the present disclosure may be more clearly understood by referring to the accompanying drawings, which are schematic and should not be construed as limiting the present disclosure in any way. In the accompanying drawings:

FIG. 1 shows a schematic diagram of the steps of a panoramic image processing method in one embodiment of the present disclosure;

FIG. 2 shows a schematic flow chart of coordinate transformation in one embodiment of the present disclosure;

FIG. 3 shows a schematic diagram of functional modules of a panoramic image processing apparatus in one embodiment of the present disclosure;

FIG. 4 shows a schematic structural diagram of an electronic device in one embodiment of the present disclosure.

### DETAILED DESCRIPTION

In order to make the purpose, technical solutions and advantages of the embodiments of the present disclosure clearer, the technical solutions in the embodiments of the present disclosure will be clearly and completely described below in conjunction with the drawings in the embodiments of the present disclosure. Obviously, the described embodiments are only part of the embodiments of the present disclosure, not all of the embodiments. Based on the embodiments of the present disclosure, all other embodiments obtained by those skilled in the art without creative work shall fall within the scope of protection of the present disclosure.

Since the fields of view of the image acquisition apparatuses usually overlap, there is often image ghosting at the junction of the fields of view in a stitched panoramic image. To solve this problem, some of the images can be cropped and then stitched together in the related art. Although this method can eliminate image ghosting, it will also cause image loss in some viewing angles.

Currently, when performing stitching of panoramic images, panoramic stitching can be performed based on templates on one hand, and can be performed based on feature matching on the other hand. When performing panoramic stitching based on templates, although it has a fast stitching speed and can be applied to business scenarios with high requirements for latency, in order to ensure the stitching effect, it is usually necessary to set a large safety distance. But in virtual reality scenarios, a large safety distance will make it impossible for users to observe the nearby environment, thus failing to achieve an immersive experience. When performing panoramic stitching based on feature matching, although there is no need to set a large safety distance, there often exists inherent parallax between multiple cameras, thus resulting in a poor stitching effect even for close-range images.

In view of this, a more holistic panoramic image stitching method is currently needed, which can eliminate image ghosting without losing images.

One embodiment of the present disclosure provides a panoramic image processing method, which estimates parallax information between different images, generates corresponding depth information based on the parallax information, and can subsequently inversely project the different images into the same device space according to the depth information, thereby obtaining, by stitching, a panoramic image that not only has no image ghosting but can also accurately display close-range objects.

According to the technical solution provided by one or more embodiments of the present disclosure, the first image and the second image captured by the image acquisition apparatuses can be converted into panoramic images first. Subsequently, it is possible to estimate the parallax information between the two converted panoramic images, and generate the corresponding depth information based on the parallax information. The depth information may be used to align different device spaces, and through the depth information, the first image and the second image originally belonging to different device spaces may be mapped into the same device space. In this way, in the same device space, the same target will only correspond to one coordinate, and there will be no duplicate targets. The panoramic images generated according to the mapping result in the same device space will not have image ghosting. Meanwhile, since the panoramic images are not cropped in the present disclosure, the contents of the original images will not be lost in the stitched panoramic image.

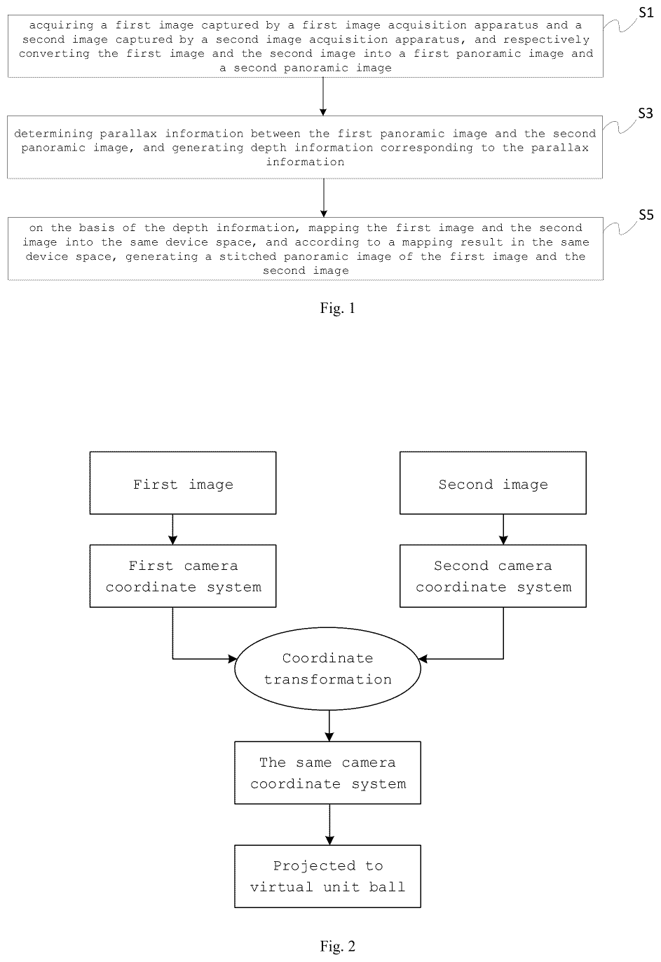

Referring to FIG. 1, a panoramic image processing method provided in one embodiment of the present disclosure may comprise the following steps.

S1: acquiring a first image captured by a first image acquisition apparatus and a second image captured by a second image acquisition apparatus, and respectively converting the first image and the second image into a first panoramic image and a second panoramic image.

In this embodiment, the image acquisition apparatuses described above may be cameras with a wide shooting range. For example, the image acquisition apparatuses may be binocular fisheye cameras. In this way, at the time of capturing images, the first image and the second image can be acquired by the first image acquisition apparatus and the second image acquisition apparatus respectively. In practical application, the first image and the second image respectively captured by the first image acquisition apparatus and the second image acquisition apparatus at the same time can be acquired. The image acquisition apparatuses have a wider shooting field of view, but consequently, there may be a certain degree of distortion in the captured images. For example, straight lines in the real world may become curved lines in the captured images. In order to accurately stitch images subsequently, the first image and the second image may be first subjected to distortion correction, so as to be converted into the corresponding first panoramic image and second panoramic image.

In practical application, the image acquisition apparatuses may be represented by different camera models. For example, taking a fisheye camera as an example, common camera models applicable to the fisheye camera may include a Kannala-Brandt Camera Model (KBCM), a Field-of-View Camera Model (FOVCM), a Double Sphere Camera Model (DSCM), and the like. Depending on different scenarios in practical application, the camera models can be flexibly selected.

It should be noted that different camera models usually have different corresponding projection functions. A projection function may transform an object from a camera coordinate system to an image coordinate system, thereby simulating an imaging process of the camera. By inverting the projection function, an inverse projection function can be obtained, which may transform pixel points in the image coordinate system back to the camera coordinate system. However, different camera models may have different computational efficiencies when the pixel points are transformed to the camera coordinate system using the inverse projection function. For example, the KBCM model requires multiple iterations to transform the pixel points in the image coordinate system to the camera coordinate system; whereas an inverse projection function of the DSCM model is an expression in a closed form, and it does not require multiple iterations to transform the pixel points to the camera coordinate system. In view of this, in a specific application example of the present disclosure, the DSCM model may be used as the camera model of the image acquisition apparatuses, so as to improve the subsequent mapping efficiency from the image coordinate system to the camera coordinate system.

In this embodiment, after the camera model of the image acquisition apparatuses is determined, a calibration coefficient of the image acquisition apparatuses can be obtained by calibrating the camera model. Generally speaking, the calibration coefficient of the image acquisition apparatuses may include an internal parameter and a distortion coefficient, wherein the distortion coefficient may be used to perform distortion correction on the pixel points in the images, thereby obtaining the corrected pixel points. The corrected pixel points can be considered to be the correct projection, in the image coordinate system, of the points in the camera coordinate system without distortion. After obtaining the corrected pixel points, the coordinates of the corrected pixel points can be transformed from the image coordinate system to the pixel coordinate system through the internal parameter. The transformed respective pixel points in the pixel coordinate system may constitute the converted panoramic images.

It can be seen that, through the calibration coefficient, the pixel points in the images can be processed carefully, and finally the images can be converted into corresponding panoramic images. For the first image acquisition apparatus, a calibration coefficient of the first image acquisition apparatus can be acquired, which may at least include an internal parameter and a distortion coefficient. Then, through the distortion coefficient, distortion correction is performed on the pixel points in the first image to obtain the corrected pixel points. After that, through the internal parameter, the corrected pixel points may be mapped into the first panoramic image, thereby generating pixel coordinates of the corrected pixel points in the first panoramic image. For the second image acquisition apparatus, a calibration coefficient of the second image acquisition apparatus can be acquired, which may at least include an internal parameter and a distortion coefficient. Then, through the distortion coefficient, distortion correction is performed on the pixel points in the second image to obtain the corrected pixel points. After that, through the internal parameter, the corrected pixel points may be mapped into the second panoramic image, thereby generating pixel coordinates of the corrected pixel points in the second panoramic image.

S3: determining parallax information between the first panoramic image and the second panoramic image, and generating depth information corresponding to the parallax information.

In this embodiment, after converting the images into the corresponding panoramic images, unlike the related art, this embodiment does not crop images of partial areas from the panoramic images and then perform epipolar rectification on the cropped area images, but directly performs epipolar rectification on the first panoramic image and the second panoramic image. The reason is that, when performing stitching of the panoramic images later, the present disclosure can eliminate image ghosting caused by the parallax in conjunction with the depth information. Therefore, when converting the images into the panoramic images, it is unnecessary to crop the panoramic images for eliminating image ghosting.

In this embodiment, epipolar rectification may be performed on the first panoramic image and the second panoramic image, so that the two panoramic images after epipolar rectification can be regarded as being captured from imaging planes parallel to each other. In this way, when pixel points in the two panoramic images are matched subsequently, the original two-dimensional search process can be simplified to a one-dimensional search process, thereby improving the matching efficiency of the pixel points.

In one embodiment, after obtaining the two panoramic images after epipolar rectification, the parallax between the two panoramic images can be estimated using a preset stereo matching network based on a convolutional neural network, thereby obtaining parallax information between the first panoramic image and the second panoramic image. The preset stereo matching network may be a CREStereo network and may repeatedly update the parallax from coarse to fine through a hierarchical network. In addition, high-resolution inference is performed using a stacked cascade architecture. In order to mitigate the negative effect of correction errors, feature matching of the pixel points can be performed using an adaptive group local correlation layer. After the parallax information between the first panoramic image and the second panoramic image is estimated through the preset stereo matching network, the depth information corresponding to the parallax information can be generated in a conventional manner.

In practical application, the depth information can be expressed as depth values of the matched pixel points in the two panoramic images. When a binocular image acquisition apparatus captures adjacent multi-frame images, the corresponding depth information can be generated for each frame of image in the above manner. In the process of generating the depth information, estimation errors may occur, causing depth values of some pixel points to jump in the adjacent multi-frame images. In view of this, it is possible to conduct statistics of depth information of the adjacent multi-frame images, and determine, based on a statistical result, whether it is necessary to generate smoothed depth information. If it is necessary to generate the smoothed depth information, the original depth information may be replaced with the smoothed depth information, thereby achieving the effect of performing inter-frame smoothing on the depth information.

Specifically, for a pixel point at any specified position in the adjacent multi-frame images, a depth value of the pixel point in the respective frames of images may be identified from the statistical result of the depth information. Generally speaking, the depth value of the pixel point in the respective frames of images should change smoothly without sudden jumps. If there is a jump value among the identified depth values, it is necessary to process the jump value, thus generating the smoothed depth information for the pixel point.

In practical application, at the time of processing the jump value to generate the smoothed depth information, it is possible to remove the jump value from the identified depth values, perform an interpolation operation on the remaining depth values, and take a result of the interpolation operation as a smoothed depth value. In this way, by the interpolation operation, each jump value can be replaced with the smoothed depth value, thereby obtaining accurate depth information.

Of course, there may be more means for performing inter-frame smoothing on the depth information, which are not limited in the present disclosure, as long as the effect of eliminating jump values can be achieved.

S5: based on the depth information, mapping the first image and the second image into the same device space, and according to a mapping result in the same device space, generating a stitched panoramic image of the first image and the second image.

Referring to FIG. 2, in this embodiment, in order to generate panoramic images without ghosting and without losing image details, pixel points in the first image may be inversely projected to a first camera coordinate system of the first image acquisition apparatus and pixel points in the second image may be inversely projected to a second camera coordinate system of the second image acquisition apparatus, through an inverse projection function of a camera model. From the foregoing description, it is clear that the efficiency of inverse projection may vary depending on the selected camera model. In one embodiment, the DSCM model may be used as a camera model of the image acquisition apparatuses, so that inverse projection from the image coordinate system to the camera coordinate system can be quickly realized.

In this embodiment, rotation and translation information between the first camera coordinate system and the second camera coordinate system may be obtained through the calibration of the camera model, and the rotation and translation information may be represented by a rotation and translation matrix. The rotation and translation matrix may include a rotation sub-matrix and a translation sub-matrix. The rotation sub-matrix may rotate the coordinate system, and the translation sub-matrix may translate the coordinate system, and through rotation and translation, two originally inconsistent camera coordinate systems may be transformed into the same camera coordinate system. Generally speaking, in the conventional calibration process, the rotation and translation information is obtained under the assumption that the depth information is 1. However, in practical application, the depth information is not necessarily 1, and in order to align two different camera coordinate systems in the same device space, a coordinate transformation matrix between the first camera coordinate system and the second camera coordinate system may be generated based on the rotation and translation information and the depth information. Specifically, it is possible to multiply a depth matrix characterized by the depth information by the rotation and translation matrix characterized by the rotation and translation information, thus obtaining the above-mentioned coordinate transformation matrix.

In this embodiment, through the coordinate transformation matrix, the inverse projection results in the first camera coordinate system and the second camera coordinate system may be mapped to the same camera coordinate system. Specifically, one of the first camera coordinate system and the second camera coordinate system may be selected as a global coordinate system, and then through coordinate transformation, the inverse projection results in the other coordinate system may be all transformed to the global coordinate system. In this way, the coordinate values originally located in different camera coordinate systems may be converted to the same camera coordinate system. For an object photographed jointly by the first image acquisition apparatus and the second image acquisition apparatus, there will only be one corresponding coordinate in the same camera coordinate system, thereby avoiding the occurrence of subsequent image ghosting.

In this embodiment, the mapping result in the same device space, after being obtained, may be projected onto a surface of a virtual unit ball. Users who view the panoramic image later may be considered to be located at the center of the virtual unit ball. The users can view 360° panoramic images by adjusting the viewing angle. Of course, in practical application, the virtual unit ball does not really exist, which is just an image processing method, and ultimately, the image obtained by unfolding the surface of the virtual unit ball along a specified longitude line may be taken as the stitched panoramic image. In this way, the length of the stitched panoramic image corresponds to the length of a latitude line, and the width of the stitched panoramic image corresponds to the length of a longitude line, and therefore, the stitched panoramic image is an image with an aspect ratio of 2:1 after being unfolded.

As can be seen, according to the technical solution provided by one or more embodiments of the present disclosure, the first image and the second image captured by the binocular image acquisition apparatus can be converted into panoramic images first. Subsequently, it is possible to estimate the parallax information between the two converted panoramic images, and generate the corresponding depth information based on the parallax information. The depth information may be used to align different device spaces, and through the depth information, the first image and the second image originally belonging to different device spaces may be mapped into the same device space. In this way, in the same device space, the same target will only correspond to one coordinate, and there will be no duplicate targets. The panoramic images generated according to the mapping result in the same device space will not have image ghosting. Meanwhile, since the panoramic images are not cropped in the present disclosure, the contents of the original images will not be lost in the stitched panoramic image.

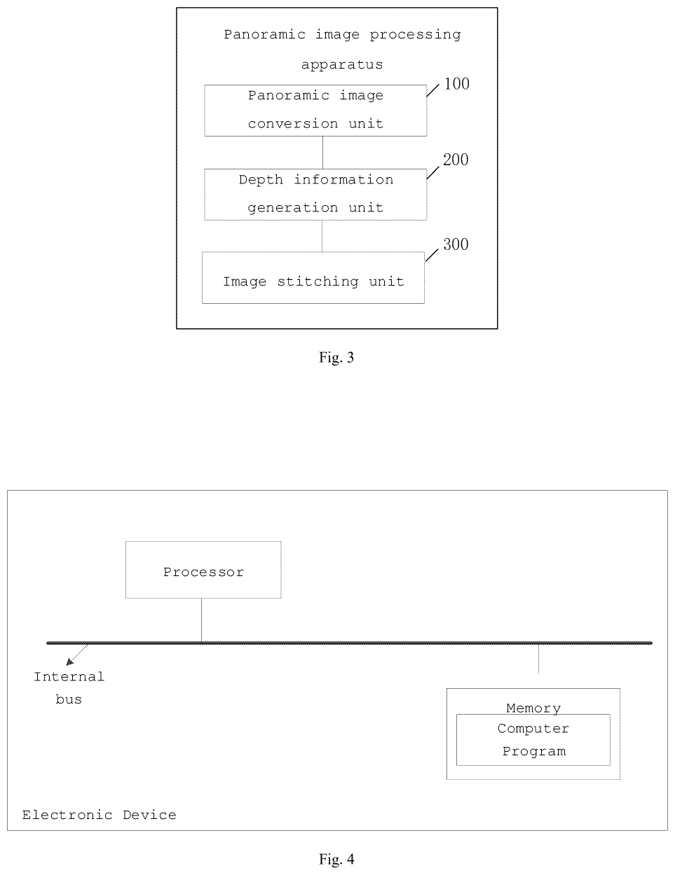

Referring to FIG. 3, one embodiment of the present disclosure further provides a panoramic image processing apparatus, comprising:
a panoramic image conversion unit 100, configured to obtain a first image captured by a first image acquisition apparatus and a second image captured by a second image acquisition apparatus, and respectively convert the first image and the second image into a first panoramic image and a second panoramic image;
a depth information generating unit 200, configured to determine parallax information between the first panoramic image and the second panoramic image, and generate depth information corresponding to the parallax information; and
an image stitching unit 300, configured to map the first image and the second image into the same device space based on the depth information, and according to a mapping result in the same device space, generate a stitched panoramic image of the first image and the second image.

Herein, the specific processing logic of the respective functional modules can be found in the description of the aforementioned method embodiments, which will not be repeated here.

The respective units set forth in the above embodiments may be implemented by a computer chip or a product with a certain function. A typical implementation device is a computer. Specifically, the computer may be, for example, a personal computer, a laptop computer, a cellular phone, a camera phone, a smart phone, a personal digital assistant, a media player, a navigation device, an email device, a game console, a tablet computer, a wearable device, or a combination of any of these devices.

For the convenience of description, the above devices are described in various units according to their functions. Of course, when implementing the present application, the functions of the respective units can be implemented in the same or multiple software and/or hardware.

Referring to FIG. 4, the present disclosure further provides an electronic device, which comprises a memory and a processor, wherein the memory is configured to store a computer program which, when executed by the processor, implements the above-mentioned panoramic image processing method.

The present disclosure further provides a computer-readable storage medium configured to store a computer program which, when executed by a processor, implements the above-mentioned panoramic image processing method.

Herein, the processor may be a central processing unit (CPU). The processor may also be other general-purpose processors, Digital Signal Processor (DSP), Application Specific Integrated Circuit (ASIC), Field-Programmable Gate Array (FPGA), or other programmable logic devices, discrete gate or transistor logic devices, discrete hardware components and other chips, or a combination of the above-mentioned types of chips.

As a non-transitory computer-readable storage medium, the memory may be configured to store non-transitory software programs, non-transitory computer executable programs and modules, such as program instructions/modules corresponding to the method in the embodiments of the present disclosure. The processor executes various functional applications and data processing by running the non-transitory software programs, instructions and modules stored in the memory, that is, implements the method in the above method embodiments.

The memory may include a program storage area and a data storage area, wherein the program storage area may store an operating system and an application program required for at least one function; the data storage area may store data created by the processor, etc. In addition, the memory may include high-speed random access memory and may also include non-volatile memory, such as at least one disk storage device, flash memory device, or other non-volatile solid-state storage device. In some embodiments, the memory may optionally include a memory remotely disposed relative to the processor, and these remote memories may be connected to the processor via a network. Examples of the above-mentioned network include, but are not limited to, the Internet, an intranet, a local area network, a mobile communication network and combinations thereof.

Those skilled in the art will understand that all or part of the processes in the above-mentioned embodiment methods can be implemented by instructing related hardware through a computer program, the program may be stored in a computer-readable storage medium, and the program, when executed, may include the processes of the embodiments of the above-mentioned methods. The storage medium may be a magnetic disk, an optical disk, a read-only memory (ROM), a random access memory (RAM), a flash memory, a hard disk drive (HDD) or a solid-state drive (SSD), etc.; the storage medium may also include a combination of the above-mentioned types of memory.

The respective embodiments in this specification are described in a progressive manner, and the same or similar parts between the respective embodiments can be referenced to each other, and each embodiment focuses on the differences from other embodiments. In particular, for the embodiments of the apparatus, device and storage medium, since they are basically similar to the method embodiments, the description is relatively simple, and for relevant parts, reference can be made to part of the description of the method embodiments.

The above description is merely embodiments of the present application and is not intended to limit the present application. For those skilled in the art, various modifications and variations may be made to the present application. Any modifications, equivalent substitutions, improvements, etc. made within the spirit and principles of the present application should be included in the scope of the claims of the present application.

Although the embodiments of the present disclosure have been described in conjunction with the accompanying drawings, those skilled in the art may make various modifications and variations without departing from the spirit and scope of the present disclosure, and such modifications and variations are all within the scope defined by the appended claims.

1. A panoramic image processing method, comprising:
acquiring a first image captured by a first image acquisition apparatus and a second image captured by a second image acquisition apparatus, and respectively converting the first image and the second image into a first panoramic image and a second panoramic image;
determining parallax information between the first panoramic image and the second panoramic image, and generating depth information corresponding to the parallax information; and
based on the depth information, mapping the first image and the second image into a same device space, and according to a mapping result in the same device space, generating a stitched panoramic image of the first image and the second image.

2. The method according to claim 1, wherein determining the parallax information between the first panoramic image and the second panoramic image comprises:
performing epipolar rectification on the first panoramic image and the second panoramic image, and for the two panoramic images after the epipolar rectification, estimating a parallax between the two panoramic images using a preset stereo matching network, to generate the parallax information between the first panoramic image and the second panoramic image.

3. The method according to claim 1, wherein mapping the first image and the second image into the same device space comprises:
inverse projecting pixel points in the first image to a first camera coordinate system of the first image acquisition apparatus, and inverse projecting pixel points in the second image to a second camera coordinate system of the second image acquisition apparatus;
determining rotation and translation information between the first camera coordinate system and the second camera coordinate system, and based on the depth information and the rotation and translation information, generating a coordinate transformation matrix between the first camera coordinate system and the second camera coordinate system; and
through the coordinate transformation matrix, mapping inverse projection results in the first camera coordinate system and the second camera coordinate system to a same camera coordinate system.

4. The method according to claim 1, wherein generating the stitched panoramic image of the first image and the second image comprises:
projecting the mapping result in the same device space onto a surface of a virtual unit ball, and taking an image obtained by unfolding the surface of the virtual unit ball along a specified longitude line as the stitched panoramic image.

5. The method according to claim 1, wherein
after generating the depth information corresponding to the parallax information, the method further comprises:
conducting statistics of depth information of adjacent multi-frame images, and determining, based on a statistical result, whether to generate smoothed depth information; and if the smoothed depth information is generated, replacing the depth information with the smoothed depth information.

6. The method according to claim 5, wherein determining, based on the statistical result, whether to generate the smoothed depth information comprises:
for a pixel point at a specified position in the adjacent multi-frame images, identifying a depth value of the pixel point in respective frames of images from the statistical result, and if there is a jump value among the identified depth values, generating the smoothed depth information for the pixel point.

7. The method according to claim 6, wherein generating the smoothed depth information for the pixel point comprises:
removing the jump value from the identified depth values, performing an interpolation operation on remaining depth values, and taking a result of the interpolation operation as a smoothed depth value.

8. The method according to claim 1, wherein converting the first image into the first panoramic image comprises:
acquiring a calibration coefficient of the first image acquisition apparatus, the calibration coefficient at least comprising an internal parameter and a distortion coefficient;
through the distortion coefficient, performing distortion correction on pixel points in the first image, to obtain the corrected pixel points; and
through the internal parameter, mapping the corrected pixel points into the first panoramic image, to generate pixel coordinates of the corrected pixel points in the first panoramic image.

9. The method according to claim 1, wherein converting the second image into the second panoramic image comprises:
acquiring a calibration coefficient of the second image acquisition apparatus, the calibration coefficient at least comprising an internal parameter and a distortion coefficient;
through the distortion coefficient, performing distortion correction on pixel points in the second image, to obtain the corrected pixel points; and
through the internal parameter, mapping the corrected pixel points into the second panoramic image, to generate pixel coordinates of the corrected pixel points in the second panoramic image.

10. (canceled)

11. An electronic device, comprising a memory and a processor, wherein the memory is configured to store a computer program which, when executed by the processor, implements a panoramic image processing method, comprising:
acquiring a first image captured by a first image acquisition apparatus and a second image captured by a second image acquisition apparatus, and respectively converting the first image and the second image into a first panoramic image and a second panoramic image;
determining parallax information between the first panoramic image and the second panoramic image, and generating depth information corresponding to the parallax information; and
based on the depth information, mapping the first image and the second image into a same device space, and according to a mapping result in the same device space, generating a stitched panoramic image of the first image and the second image.

12. A non-transitory computer-readable storage medium, configured to store a computer program which, when executed by a processor, implements a panoramic image processing method, comprising:
acquiring a first image captured by a first image acquisition apparatus and a second image captured by a second image acquisition apparatus, and respectively converting the first image and the second image into a first panoramic image and a second panoramic image;
determining parallax information between the first panoramic image and the second panoramic image, and generating depth information corresponding to the parallax information; and
based on the depth information, mapping the first image and the second image into a same device space, and according to a mapping result in the same device space, generating a stitched panoramic image of the first image and the second image.

13. The electronic device according to claim 11, wherein determining the parallax information between the first panoramic image and the second panoramic image comprises:
performing epipolar rectification on the first panoramic image and the second panoramic image, and for the two panoramic images after the epipolar rectification, estimating a parallax between the two panoramic images using a preset stereo matching network, to generate the parallax information between the first panoramic image and the second panoramic image.

14. The electronic device according to claim 11, wherein mapping the first image and the second image into the same device space comprises:
inverse projecting pixel points in the first image to a first camera coordinate system of the first image acquisition apparatus, and inverse projecting pixel points in the second image to a second camera coordinate system of the second image acquisition apparatus;
determining rotation and translation information between the first camera coordinate system and the second camera coordinate system, and based on the depth information and the rotation and translation information, generating a coordinate transformation matrix between the first camera coordinate system and the second camera coordinate system; and
through the coordinate transformation matrix, mapping inverse projection results in the first camera coordinate system and the second camera coordinate system to a same camera coordinate system.

15. The electronic device according to claim 11, wherein generating the stitched panoramic image of the first image and the second image comprises:
projecting the mapping result in the same device space onto a surface of a virtual unit ball, and taking an image obtained by unfolding the surface of the virtual unit ball along a specified longitude line as the stitched panoramic image.

16. The electronic device according to claim 11, wherein after generating the depth information corresponding to the parallax information, the computer program further implements:
conducting statistics of depth information of adjacent multi-frame images, and determining, based on a statistical result, whether to generate smoothed depth information; and if the smoothed depth information is generated, replacing the depth information with the smoothed depth information.

17. The electronic device according to claim 16, wherein determining, based on the statistical result, whether to generate the smoothed depth information comprises:
for a pixel point at a specified position in the adjacent multi-frame images, identifying a depth value of the pixel point in respective frames of images from the statistical result, and if there is a jump value among the identified depth values, generating the smoothed depth information for the pixel point.

18. The non-transitory computer-readable storage medium according to claim 12, wherein determining the parallax information between the first panoramic image and the second panoramic image comprises:
performing epipolar rectification on the first panoramic image and the second panoramic image, and for the two panoramic images after the epipolar rectification, estimating a parallax between the two panoramic images using a preset stereo matching network, to generate the parallax information between the first panoramic image and the second panoramic image.

19. The non-transitory computer-readable storage medium according to claim 12, wherein mapping the first image and the second image into the same device space comprises:
inverse projecting pixel points in the first image to a first camera coordinate system of the first image acquisition apparatus, and inverse projecting pixel points in the second image to a second camera coordinate system of the second image acquisition apparatus;
determining rotation and translation information between the first camera coordinate system and the second camera coordinate system, and based on the depth information and the rotation and translation information, generating a coordinate transformation matrix between the first camera coordinate system and the second camera coordinate system; and
through the coordinate transformation matrix, mapping inverse projection results in the first camera coordinate system and the second camera coordinate system to a same camera coordinate system.

20. The non-transitory computer-readable storage medium according to claim 12, wherein generating the stitched panoramic image of the first image and the second image comprises:
projecting the mapping result in the same device space onto a surface of a virtual unit ball, and taking an image obtained by unfolding the surface of the virtual unit ball along a specified longitude line as the stitched panoramic image.

21. The non-transitory computer-readable storage medium according to claim 12, wherein after generating the depth information corresponding to the parallax information, the computer program further implements:
conducting statistics of depth information of adjacent multi-frame images, and determining, based on a statistical result, whether to generate smoothed depth information; and if the smoothed depth information is generated, replacing the depth information with the smoothed depth information.
